(19) United States
(12) Patent Application Publication
(10) Pub. No.: US 2009/0029079 A1
(43) Pub. Date: Jan. 29, 2009

(54) Nylon Food Casing

(75) Inventors: Aamir W. Siddiqui, Naperville, IL (US); Amy L. Glawe, Downers Grove, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: VISKASE COMPANIES, INC., Darien, IL (US)

(21) Appl. No.: 12/176,098

(22) Filed: Jul. 18, 2008

Related U.S. Application Data
(60) Provisional application No. 60/961,620, filed on Jul. 23, 2007.

(51) Int. Cl. A22C 13/00; A23P 1/12

(52) U.S. Cl. 428/34.8; 426/514

(57) ABSTRACT

Tubular, biaxially stretched, heat shrinkable seven layer film food casings comprising inner polyamide layer and two outer polyamide or functional group modified polyolefin layers on either side of core layers of EVOH and polyethylene, having two adhesive layers, and a coextrusion process for making the film.

### CROSS-REFERENCE TO RELATED APPLICATIONS

This application claims the benefit of U.S. Provisional No. 60/961,620, filed Jul. 23, 2007, which is incorporated by reference in its entirety.

### BACKGROUND OF THE INVENTION

The present invention relates to oriented nylon casings, particularly food casings suitable for making sausage, ham in mold products, and D-shaped products.

Tubular films are used as sausage casings for processing and packaging cooked foods including water or steam cooked sausages, such as liver sausage and fleischwurst, hams processed in molds, and “D” shaped foods such as turkey breasts with one flat side.

The selection of films for packaging food products includes consideration of a number of criteria such as cost, abrasion resistance, wrinkle resistance, meat adhesion, dimensional uniformity and stability, stiffness, strength, printability, durability, oxygen and water barrier properties, stretchability, machinability, optical properties such as haze, gloss, and freedom from streaks and gels, and safety for contact with food.

In general, commercial sausage making operations for making water cooked or steam cooked sausages require casings made from materials able to perform well in the following typical process steps:
1. Stuffing with meat emulsion to a uniform diameter;
2. Clipping or otherwise sealing the casing about its circumference to form discrete logs;
3. Cooking the encased sausage to temperatures of at least 65-100° C. ;
4. Chilling the cooked encased sausages to 4° C. or less;
5. Optionally cutting the logs into discrete lengths or slices; and
6. Repackaging cut logs or slices by vacuum packaging.

Sausages so made must be uniform in size and must be wrinkle free.

Other uses for casings include processing hams-in-mold and meat products such as turkey breasts or loaf products. Hams processed in molds are processed by encasing a ham or a portion of one in a casing, cutting the casing to form a loose package around the ham, clipping or sealing the casing end, placing the ham into a mold, squeezing it and closing the lid, cooking the ham in the mold, and releasing it from the mold and ultimately removing the casing. After cooking, ham in mold products must have square corners and must be of certain dimensions to fit into vacuum sealed cans that are sold to the final customer.

“D” shaped foods are similarly processed as in ham in mold, except that once the turkey meat, for example, is encased, it is placed on a tray and then further heat processed. The bottom edge is flattened, giving the processed turkey a “D” shape, thereby imitating the shape of a bone-in turkey breast. A product having a more oval shape, the manufacturer would consider the product unacceptable. A similar situation exists for loaf shaped products, which may later be sliced as deli meats. These products must not become rounded during processing, but rather must retain the desired D or loaf shape.

The various required shapes and wrinkle-free features of the finished products are provided by the use of the correct type of casing.

Various monolayer and multilayer casings have been proposed and used commercially to make processed foods. Moisture barrier properties are important to prevent loss of water during and after cooking. Desirably, these casings will also have low oxygen permeability to avoid discoloration, adverse flavor changes, and oxidation of the food stuff during storage. Liver sausage in particular is easily susceptible to defects when contacted with excessive oxygen, resulting in discoloration,

Furthermore, it is highly desirable to produce an encased cooked food stuff that exhibits a tight fitting casing having few or no wrinkles even after prolonged storage. There should be a minimum of spaces or pockets between the food mass and the inside of the casing since such spaces or pockets promote separation and collection of fats, liquid and gelatinous materials in such spaces which leads to a non-uniform meat or sausage appearance that is unappetizing and undesirable to consumers.

Cellulose casings of, e.g., fiber reinforced regenerated cellulose coated with moisture barrier coatings such as a polyvinylidene chloride copolymer (“PVDC”), e.g., saran, have been commercialized, as have monolayer casings made of PVDC. These casings have excellent oxygen and moisture barrier properties along with excellent dimensional uniformity and stability, but are expensive to produce compared to plastic casings.

To ameliorate the aforementioned problems and costs associated with coated cellulosic casings, several polyamide casings have been introduced into the market. Monolayer and multilayer polyamide casings have been commercialized and both non-shrinkable and shrinkable casings have been made by blown film and oriented film processes, both processes well known in the art.

As discussed in U.S. Pat. No. 4,303,711, “single-layer, unstretched plastic casings consisting of higher homopolyamides (polyamide 11 and polyamide 12)” are known as well as plastic casings consisting of such polyamides coextruded in two layers with polyamide 6 as the outer layer. These polyamide casings may be easily made by the blown film technique, but typically suffer from a lack of dimensional stability and uniformity, being deformed upon stuffing so that production of stuffed sausages to a uniform diameter is difficult. The '711 patent further indicates that these unstretched films suffer from an undesirably wrinkled appearance after cooking and chilling.

Various attempts have been made at making stretch oriented polyamide casings. Uniaxially stretched casings which are only stretched in the longitudinal (machine) direction (“MD”) reportedly have the same disadvantages as unstretched casings regarding insufficient dimensional stability, nonuniformity of diameter and excessive wrinkling.

U.S. Pat. No. 4,560,520 (Erk et al.) discloses forming multiaxially stretched, monolayer, polyamide, tubular films, e.g., of nylon 6 or nylon 66 which have elastic properties and which are said to be used for packaging table sausages and boiled sausages. The disclosed films are “fixed thermally” and shrunk after stretching, e.g., by subjecting the tube to controlled shrinkage of at least 15% and at most 40% at temperatures above 90° C. and also subjecting the film to infrared irradiation. This is to produce a nylon casing which does not have shrinkage at temperatures under 90° C. This pre-shrunk casing is used for stuffing with meat emulsion and relies upon its elastic properties to provide wrinkle resistance.

This patent goes on to refer to a “shrinkable multiaxially stretched thermally fixed sausage casing of polyamide”, which remains close fitting but suffers from insufficient resistance to tearing. The assignee of this patent, Naturin-Werk Becker & Company has commercialized several monolayer nylon casings under the trademarks Optan, Betan and Tripan.

Nylon monolayer casings whether made by the blown film process or the stretch oriented film process are disadvantageously sensitive to moisture. As noted above, it is desirable for casings used to package fleischwurst and liver sausage-type products to have low permeability to steam or water. Also, moisture is known to adversely affect the oxygen barrier properties of many nylons causing an undesirable increase in oxygen transmission rates when wet. In view of these disadvantages, attempts have been made to utilize blends of nylon with other materials to enhance properties such as gas and water vapor impermeability. For example, U.S. Pat. No. 4,303,711 discloses a plastic casing made from a mixture of polyamide and ionomer. Also, the company Hoechst AG has commercialized what are believed to be monolayer casings containing blends of polyamide and polyester.

Furthermore, attempts have been made to use nylon in biaxially stretched multilayer casing to overcome these disadvantages. For example, U.S. Pat. No. 4,888,223 discloses 2 to 5 layer heat shrinkable tubular structures all having polyamide in either the outer layer or core layer and having a polyolefin inner layer that is corona treated for meat adhesion.

Also, U.S. Pat. No. 4,855,183 discloses a multilayer tubular shrink film having a polyamide inner layer which is irradiated to promote meat adhesion and which has additional polyolefinic layers which may comprise materials such as ethylene vinyl acetate (“EVA”), ethylene methylacrylate polyethylene (“EMA”), ethylene ethylacrylate (“EEA”), linear low density polyethylene (“LLDPE”), very low density polyethylene (“VLDPE”), linear low density polyethylene (“LDPE”), high density polyethylene (“HDPE”) or medium density polyethylene (“MDPE”).

Disadvantageously, the above '223 and '183 patents disclose structures that require a corona treatment or irradiation step to enhance meat adhesion thereby requiring additional equipment, processing time and/or cost.

U.S. Pat. No. 5,185,189, issued on Feb. 9, 1993 to Stenger, discloses a multilayer casing which may consist of a three layer coextruded and biaxially oriented tube which, if desired, may be “thermofixated”. A structure having inner and outer polyamide layers separated by a middle layer of polyolefin, blended with or coated with an adhesion imparting component, is disclosed for use as a sausage casing with low permeability to steam and oxygen. The middle layer is preferably a polyolefin blended with an adhesion imparting component in a portion which in general is 5-50 weight % based on the polymer blend present in the middle layer. According to this document, the portion of the adhesion imparting component is preferably 10 to 35% by weight but “should be kept as low as possible”. This adhesion component is viewed as being required to prevent layer separation during cooking in hot water. Useful adhesion imparting agents are disclosed as including polyolefin resin modified with functional groups such as vinyl acetate, acrylic acid and methacrylic acid, as well as their esters and salts, and furthermore, ethylenically unsaturated carboxylic anhydride groups. These casings are oriented by biaxial stretching. To improve dimensional stability after stretching, the casing is annealed to produce a material having a shrinkage of less than 20%, preferably less than 15%, in both vertical and horizontal directions, at temperatures of up to 90␣C. Elastic behavior and shrinkage during drying are relied upon to provide a purportedly tight wrinkle free fit.

Unfortunately, orientation of seamless tubes of nylon by biaxial stretching is difficult. Extrusion and orientation of multilayer tubes, especially coextruded tubes, containing mixed layers of polyamides and other materials having different melting points, melt viscosities, and a different affinity for water can be very difficult. For example, U.S. Pat. No. 4,892,765 (Hisazumi et al.) notes that although it is desirable to extrude films for packaging hams and sausages in tubular form, it is difficult to make a stretched tubular polyamide film of uniform thickness. This patent also notes that layer adhesion becomes weak when multilayer, polyamide films are stretched. Hisazumi et al. disclose production of a heat shrinkable multilayer film having a core layer of a PVDC attached to opposing polyamide layers (e.g., of nylon 6/66 copolymer) by opposing adhesive layers. This film is made using an orientation process which utilizes water to soften and plasticize the nylon to a degree sufficient to allow or facilitate orientation. The orientation processes employed for nylon multilayer casing have tended to involve complicated apparatus and processing such as that found in U.S. Pat. No. 4,886,634. Cook-in pouches developed by Viskase Corp. and known as “Cook-Tite” are made of layers arranged as polyolefin/adhesive/ethylene vinyl alcohol/adhesive/polyolefin. Raw meats are placed inside such pouches, sealed and then subjected to cooking.

U.S. Pat. No. 5,549,943 issued on Aug. 27, 1996, to Vicik, describes a blown, heat shrinkable, multilayer nylon film that offers moisture resistance.

U.S. Pat. No. 5,698,279, issued on Dec. 16, 1997, to Vicik, describes a multilayer tubular film comprising the structure of inner and outer layers of polyamide, with a core layer of a blend of EVA and another polyolefin such as ethylene methacrylic acid copolymer, providing casing with good oxygen barrier properties.

U.S. Pat. No. 5,747,124, issued on May 5, 1998 to Pophusen, describes a tubular film having at least four layers, where the inner and outer layers are polyamides, and the enclosed two layers are oxygen barrier layer, such as EVOH, and an polyolefin, having a quotient of tear resistance of TD/MD of less than or equal to 0.85.

U.S. Pat. No. 5,985,386, issued on Nov. 16, 1999 to von Widdern claims a multilayered, biaxially oriented tubular sausage casing made of a film of at least four layers where the inner and outer layers are a polyamide or blend of a number of polyamides and where at least either the inner or outer layer polyamide also is blended with another polyamide, copolyamide or polyolefin copolymer; and where there is a center water barrier layer of a variety of polyolefins; and another center layer of ethylene vinyl alcohol. In its examples, '386 also discloses a feature of this film whereby the inner polyamide layer(s) are thicker than the outer layer, which may at least partially account for the barrier features of this film. This provides for a casing that has oxygen and moisture barrier properties suitable for longer storage life for the encased sausages. No teaching is made of the use of this film to produce ham in mold or D shaped products.

U.S. Pat. No. 6,194,040 B1, issued on Feb. 27, 2001 to Delius et al., also describes a casing useful for longer term storage of encased sausage. A tubular, biaxially-oriented casing having four layers, where the outer layer is a mixture of two polyamides, a first intermediate layer is ethylene vinyl alcohol blended with a copolyamide, an olefinic polymer, or an ionomer, a second intermediate layer of an polyolefin, and an inner layer of an aliphatic polyamide.

In summary, although several of the aforementioned plastic casing products have gained varying degrees of commercial acceptance in different market segments, their advantage compared to the traditional cellulosic casing has been chiefly one of cost with the problems of dimensional stability, uniformity of diameter, and wrinkling being persistent concerns.

Prior art fiber reinforced cellulose casings coated with moisture barrier coatings perform well in processing water/steam cooked sausages such as fleischwurst and liver sausage. However, the high cost of manufacture of such casings has led casing manufacturers to search for less expensive alternatives. Thermoplastic films of various compositions have been suggested and some have found varying degrees of success in various segments of the market. Thermoplastic sheet film has been made into a tube by seaming, but this is a difficult process which produces a casing having a seamed area which may undesirably differ in appearance and performance relative to an unseamed casing.

Seamless tubular thermoplastic casings have been made which overcome the objections to seamed casings. Various materials have been employed, but materials containing chlorinated polymers have been objected to for environmental reasons among others. Seamless polyamide casings have been made of blown film, however these casings tend to have poor performance with respect to wrinkling, uniformity of diameter, and dimensional stability. Seamless biaxially oriented multilayer films have also been made. However such films have been difficult to produce, requiring special blend formulations and structures or complicated equipment and procedures.

Therefore, it is an object of the present invention to provide a multilayer, biaxially stretched, heat shrinkable, thermoplastic film useful as a casing for foodstuffs of both regular and irregular shapes, needing moisture and oxygen barriers during processing and afterward, such as sausages or ham in mold products, which includes among its desirable properties one or more of the following:
a) sufficient flexibility and softness to facilitate shirring and subsequent stuffed log formation or irregular shapes by gathering of the casing and clipping to form the ends;
b) resistance to permanent deformation during stuffing, cooking and chilling, and maintenance of a symmetrical cylindrical shape, if needed, with a minimum of curvature or bulging;
c) an acceptable, to the final customer, level of change of height of the packaging between the preprocessed and the postprocessed products, when the products must have a final D shaped configuration.
d) an ability to adhere to both the regularly or irregularly shaped food during expansion and contraction of the food during cooking and chilling;
e) resistance to bursting or tearing during stuffing, when pressure is applied to force the encased foodstuff into a mold, during cooking at elevated temperatures, and during subsequent handling;
f) resistance to wrinkling during processing and handling;
g) little or no moisture loss during cooking and storage, i.e., high cooking yield;
h) resistance to passage of oxygen in order to prevent spoilage; and
i) an ability to be cut or sliced easily without edge curling or splitting, and to be removed without damaging the surface of the foodstuff

It is a further object of the present invention to provide a tubular film having a unique combination of shrink, mechanical strength and barrier properties suitable for use as a foodstuff casing, where the foodstuffs include both regularly shaped chubs and irregularly shaped foodstuffs such as meat parts.

It is a further object of the present invention to provide a polyamide sausage casing having a polyamide inner layer which adheres to meat without requiring addition of starch based additives or treatment with electron beam irradiation or corona discharge.

It is a further object of the present invention to provide a multilayer oriented structure having sufficient shrinkage values and shrink force values to provide good conformation of the casing to the filling after cooking, chilling and storage.

It is a further object of the present invention to provide an improved biaxially stretched, heat shrinkable polyamide multilayer casing, that in addition, can accept coloring in a discrete layer.

### SUMMARY OF THE INVENTION

The foregoing objectives may be provided according to the present invention, in a novel tubular, biaxially stretched, heat shrinkable, multilayer thermoplastic film, food casing. This newly disclosed film casing has at least seven layers, described from outer to inner layer, comprising: an outer surface layer (A) comprising a polyamide or a polyolefin modified with functional groups; a second layer (B) comprising a polyamide; a first adhesive layer (C) comprising an polyolefin modified with functional groups: a first core layer (D) comprising a (i) copolymer of ethylene and an unsaturated ester, or (ii) one or more of polyolefins comprising a low density polyethylene (“LDPE”), a high density polyethylene (“HDPE”), a linear low density polyethylene (“LLDPE”), and very low density polyethylene (“VLDPE”); a second adhesive layer (E) of a polyolefin modified with functional groups; a second core layer (F) comprising ethylene vinyl alcohol copolymer (“EVOH”); and an inner surface layer (G) comprising a polyamide, wherein the inner surface layer (G) is a food contacting layer and the outer surface layer (A) is a non-food contacting layer.

In one embodiment of this aspect of the invention, when the outer surface layer (A) is polyamide, the inner surface layer (G) is thinner than the outer surface layer (A).

In another embodiment, when the outer surface layer (A) is a polyolefin modified with function groups, the outer surface layer (A) is thinner than the inner surface layer (G).

In another embodiment, the polyamide comprises a homopolyamide, a copolyamide, blends of copolyamides, or blends of copolyamides and homopolyamides.

In another embodiment, the first core layer (D) further comprises a polyolefin based color master batch in a blend with the (i) copolymer or the (ii) one or more of polyolefins.

In another embodiment, the polyolefin modified with functional groups comprises maleic anhydride grafted LLDPE, maleic anhydride grafted ethylene vinyl acetate (“EVA”), or maleic anhydride grafted LLDPE blended with a polyolefin based color master batch.

In another embodiment, the film has a shrinkage value of about 3% to about 30% in both the machine and transverse direction (“MD” and “TD”) at 90° C. and from 0% to about 8% at 60° C.

In another embodiment, the polyamide outer (A) comprises (iii) nylon 6/66 copolymer either alone or blended with nylon 66/610 copolymer or nylon 6 homopolymer or (iv) maleic anhydride grafted LLDPE; the second layer (B) comprises a nylon 6/66 copolymer, nylon 6/12 copolymer, or nylon 6 homopolymer; the adhesive layer (C) comprises maleic anhydride grafted LLDPE; the first core layer (D) comprises EVA; the second core layer (F) comprises EVOH having between about 32 to about 44 mole % ethylene; the adhesive layer (E) comprises maleic anhydride grafted LLDPE; and the second core layer (F) comprises EVOH having between about 32 to about 44 mole % ethylene;; and the inner (G) surface comprises nylon 6/66 copolymer either alone or blended with nylon 66/610 copolymer or nylon 6 homopolymer, wherein the interior surface layer has a thickness that is less than that of the exterior surface layer.

In another embodiment, the EVOH has between about 32 to about 44 mole % ethylene.

In another embodiment, the film has a thickness of about 25 to about 70 microns.

In another embodiment, the film further comprising one or more additional layers of either or both of the inner or outer surface layers of the tube.

In another embodiment, the film further comprising one or more additional layers (A), (B), (C), (D), (E), (F) or (G).

In another embodiment, the thickness of:
outer surface layer A ranges from about 6.00μ to about 20.00μ;
second layer B ranges from about 6.00μ to 20.00μ;
first adhesive layer C ranges from about 2.00μ to about 10.00μ;
first core layer D ranges from about 2.00μ to about 20.00μ;
second adhesive layer E ranges from about 6.00μ to about 10.00μ;
second core layer F ranges from about 0.750μ to about 5.00μ; and
inner surface layer G ranges from about 2.00μ to about 13.00μ.

In another embodiment, the inner surface layer (G) is continuous over the inner surface of the tube and extruded at a sufficient thickness to allow the desired degree of stretching without forming discontinuities in coverage.

In another embodiment, the outer surface layer (A) comprises a polyamide or a polyolefin modified with functional groups; each of the inner surface layer (G), and the second layer (B) comprise a polyamide; each of adhesive layers (C) and (E) comprise maleic anhydride grafted LLDPE, maleic anhydride grafted ethylene vinyl acetate (“EVA”), or maleic anhydride grafted LLDPE blended with a polyolefin based color master batch; the first core layer (D) comprising an EVA having about 8-12% vinyl acetate units, the EVA optionally blended with polyolefin based color master batch; the second core layer F comprising EVOH.

In another embodiment, each of the layers(C) and (E) is further blended with a polyolefin master color batch.

In another embodiment, the inner surface layer (G) comprise nylon 6, nylon 6/12 copolymer, nylon 66/610 copolymer, or nylon 6/66 copolymer and outer surface layer (A) comprise nylon 6, nylon 6/12 copolymer, nylon 66/610 copolymer, nylon 6/66 copolymer, or maleic anhydride grafted LLDPE.

In another embodiment, the inner surface layer (G) comprise nylon 6/66, alone or blended with nylon 66/610 or nylon 6, and outer surface layer (A) comprise nylon 6/66, a blend of nylon 6/66 with nylon 66/610 or nylon 6, nylon 6/66 copolymer, or maleic anhydride grafted LLDPE.

In another embodiment, the inner surface layer (G) comprises nylon 6 and the outer surface layer (A) comprise co-polyamide nylon 6/66 or maleic anhydride grafted LLDPE.

In another embodiment, the second layer (B) comprises nylon 6/66 copolymer, nylon 6,12 copolymer or nylon 6 homopolymer, or blends of any one of the foregoing.

In another embodiment, the inner surface layer (G) is the interior surface layer of the tubular food casing and has the characteristic of adhering to meat.

In another embodiment, the outer surface layer (A) comprises a copolyamide, preferably nylon 6/66 or maleic anhydride grafted LLDPE.

In another embodiment, the polyamide comprises a nylon having a relative viscosity (ηᵣ) in 98% sulfuric acid of greater than about 4Θᵣᵣ.

In another embodiment, the nylon has a relative viscosity value of 4 and above.

In another embodiment, the polyolefin modified with functional groups comprises a LLDPE having a density ranging from about 0.915 to about 0.940 g/cm³.

In another embodiment, the polyolefin modified with functional groups comprises grafted polymers of LLDPE.

In another embodiment, the grafted polymers of LLDPE is a LLDPE grafted maleic anhydride.

In another embodiment, the unsaturated ester comprises vinyl acetate.

In another embodiment, the copolymers of ethylene and unsaturated ester comprise copolymers of ethylene-vinyl acetate, copolymers of ethylene-methyl methacrylate, copolymers of ethylene-ethyl methacrylate, or copolymers of ethylene-alkyl acrylates. The copolymers of ethylene-alkyl acrylates comprise ethylene-methyl acrylate, ethylene-ethyl acrylate or ethylene-butyl acrylate.

In another embodiment, the EVOH copolymer generally comprises between about 32 to about 44 mole % ethylene units, usually between about 32 to about 44 mole % ethylene units, typically about 32 mole % ethylene units.

In another aspect of the invention, a tubular, biaxially stretched, heat shrinkable, multilayer thermoplastic film food casing is provided, the film comprises:
an inner layer (G) comprising a blend of Nylon 6 homopolymer and antiblock nylon;
adhesive layers (C) and (E) comprise maleic anhydride grafted LLDPE;
a first core layer (D) comprises EVA or a blend of about 50% EVA with about 50% polyethylene based color master batch;
a second core layer (F) comprising EVOH with about 32% by mole ethylene;
an outer layer (A) comprises Nylon 6/66 or maleic anhydride grafted LLDPE; and
second layer (B) comprises Nylon 6/66.

In one embodiment of this aspect of the invention, each of outer layer (A) and second layer (B) comprises about 25% of the film layer thickness;
first adhesive layer (C) and second adhesive layer (E), each layer comprising about 11% of the film layer thickness;
first core layer (D) comprises about 10% of the film layer thickness;
second core layer (F) comprises about 3% of the film layer thickness; and
inner layer (G) comprises about 15% of the film layer thickness.

In another embodiment, the each of the outer layer (A) and second layer (B) comprises about 25% of the film layer thickness;
first adhesive layer (C) and second adhesive layer (E) each comprise about 10% of the film layer thickness;
first core layer (D) comprises about 10% of the film layer thickness;
second core layer (F) comprises about 5% of the film layer thickness; and
inner layer (G) comprises about 15% of the film layer thickness.

In another aspect of the invention, a continuous process for making a tubular, biaxially stretched, heat shrinkable, multilayer thermoplastic food casing is provided, the process comprising the steps of:
(a) co-extruding a melt plasticized multilayer thermoplastic tube having an exterior surface and an interior surface through an annular die wherein the tube comprises an outer layer comprising a polyamide or a polyolefin modified with functional groups, a second polyamide layer, an first adhesive polyethylene layer, a first core layer of EVA, a second adhesive polyethylene layer, a second core layer of EVOH, and an outer polyamide layer;
(b) cooling the coextruded tube below the melting point of each layer by applying water to the exterior surface of the tube;
(c) transferring the cooled tube to an orientation zone wherein the tube is reheated to a temperature below the melting point of the tube layer with the lowest melting point, followed by cooling while a fluid mass is admitted to the interior of the tube as said tube is passed between first and second means for blocking fluid flow along the interior of the tube, thereby causing the tube to stretch circumferentially about the entrapped fluid mass and simultaneous with the circumferential stretching, the tube is stretched in a direction perpendicular thereto to produce a biaxially stretched tubular film; and
(d) annealing the biaxially stretched film at elevated temperature to dimensionally stabilize the film.

In another embodiment of the invention, The film casing comprises: a non-food contacting outer layer (A) comprising a copolyamide, or blends of copolyamides, or blends of copolyamides and homopolyamides; a second layer (B) in contact with the outer layer comprising a copolyamide, or blends of copolyamides, or blends or copolyamides and homopolyamides; a first adhesive layer (C) of a polyolefin modified with functional groups, such as a maleic anhydride grafted linear low density polyethylene (“LLDPE”), a LLDPE blended with ethylene vinyl acetate (“EVA”) or maleic anhydride grafted LLDPE blended with polyolefin based color master batch; a first core layer (D) of copolymers of ethylene containing 8-12% of vinyl acetate, preferably EVA, or of one or more polyolefins such as low density polyethylene (“LDPE”), high density polyethylene (“HDPE”), LLDPE, and very low density polyethylene (“VLDPE”) or blended with polyolefin based color master batch; a second adhesive layer (E) of a polyolefin modified with functional groups, such as a maleic anhydride grafted LLDPE, a LLDPE blended with EVA, or maleic anhydride grafted LLDPE blended with a polyolefin based color master batch; a second core layer (F) comprising ethylene vinyl alcohol copolymer (“EVOH”); and an inner layer (G) comprising a copolyamide, or blends of copolyamides, or blends or copolyamides and homopolyamides. The inner polyamide layer (G) is thinner than the outer layer (A) when the outer layer comprises a polyamide. The inner polyamide layer (G) is thicker than the outer layer (A) when the outer layer comprises a polyolefin modified with functional groups. The multilayer film has a shrinkage value of from about 3% to about 30% in both the machine and transverse direction (“MD” and “TD”) at 90° C. and from 0% to about 8% at 60° C.

These inventive films are surprisingly easy to process and orient and have excellent optical properties. They are capable of being shirred and used as casings, for both regularly shaped sausages and irregularly shaped meat products, with fewer wrinkles than many commercialized prior art nylon casings. They do not require “after shrinking”; the layers adhere well to one another without delamination and have excellent dimensional stability, uniformity of diameter and appearance.

The present invention provides a relatively simple process and multilayer film which achieves a high degree of performance in providing a dimensionally stable film of uniform diameter which is suitable for shirring, stuffing, cooking and general manufacture of both sausages and irregularly shaped meats, such as in ham in mold and “D” shaped food products, and a tight wrinkle-free appearance without requiring an after shrinking step.

Preferably, the inventive melt plasticized, coextruded, thermoplastic tube has a polyamide outer A and inner G surface of nylon 6/66 copolymer either alone or blended with nylon 66/610 copolymer or nylon 6 homopolymer; the second layer B of a nylon 6/66 copolymer, nylon 6/12 copolymer, or nylon 6 homopolymer; adhesive layers C and E being maleic anhydride grafted LLDPE; the first core layer (D) comprises EVA; and the second core layer F is EVOH preferentially having about 32 mole % ethylene. The interior surface layer (G) will have a thickness that is less than that of the exterior surface layer (A) when A comprises polyamide. When exterior surface layer (A) comprises polyolefin modified with functional groups, the interior surface layer (G) is thicker than that of the exterior surface layer (A).

### DETAILED DESCRIPTION OF THE INVENTION

The invention in all of its embodiments comprises or utilizes a heat shrinkable, biaxially stretched, multilayer, thermoplastic, polymeric flexible film. This film has a thickness of about 25 to about 70 microns. This film provides a beneficial combination of properties including ease of shirring and stuffing with low cost, good mechanical strength, good adhesion, and good oxygen and water barrier properties.

The inventive article is a heat shrinkable, multilayer film having at least seven layers as described from outer to inner layer, wherein the non-food contacting outer layer (A) comprises a polyamide or a polyolefin modified with functional groups; a second layer (B) comprises a polyamide; a first adhesive layer (C) comprises an polyolefin modified with functional groups: a first core layer (D) comprises a (i) copolymer of ethylene and an unsaturated ester, or (ii) one or more of polyolefins comprising a low density polyethylene (“LDPE”), a high density polyethylene (“HDPE”), a linear low density polyethylene (“LLDPE”), and very low density polyethylene (“VLDPE”); a second adhesive layer (E) comprises a polyolefin modified with functional groups; a second core layer (F) comprises ethylene vinyl alcohol copolymer (“EVOH”); and an inner surface layer (G) comprises a polyamide, wherein the inner surface layer (G) is a food contacting layer and the outer surface layer (A) is a non-food contacting layer.

In another aspect, the inventive article is a heat shrinkable, multilayer film having at least seven layers as described from outer to inner layer, wherein the non-food contacting outer layer (A) comprises a copolyamide, or blends of copolyamides, or blends or copolyamides and homopolyamides; a second layer (B) in contact with the outer layer comprising a copolyamide, or blends of copolyamides, or blends of copolyamides and homopolyamides; a first adhesive layer (C) of a polyolefin modified with functional groups, such as maleic anhydride grafted LLDPE, maleic anhydride grafted ethylene vinyl acetate (“EVA”), or maleic anhydride grafted LLDPE blended with a polyolefin based color master batch; a first core layer (D) of copolymers of ethylene containing 8-12% of vinyl acetate, preferably EVA, or of one or more polyolefins such as LDPE, high density polyethylene HDPE, LLDPE, and very low density polyethylene VLDPE, or blended with a polyolefin based color master batch; a second adhesive layer (E) of a polyolefin resin modified with functional groups, such as a maleic anhydride grafted LLDPE, maleic anhydride grafted ethylene vinyl acetate (“EVA”), or maleic anhydride grafted LLDPE blended with a polyolefin based color master batch; a second core layer (F) comprising EVOH; and an inner layer (G) comprising a copolyamide, or blends of copolyamides, or blends or copolyamides and homopolyamides. Preferably, the polyamide inner layer will comprise the interior surface layer of the tube where in use it will contact a foodstuff encased by the tube, and it will be thinner than the outer layer.

Tubular films having more than these seven layers may be constructed with additional layers comprising one or more surface layers and comprise either or both the interior or exterior surface of the tube, or additionally by providing multiple layers of any one or more of the described layers of the inventive film, and not only be producing, for example, two layers of layer D falling within the same thickness range as described herein for only one layer of layer D, but also by exceeding the described thickness range while maintaining the properties described herein.

Each layer of the inventive film has the following thickness range (in microns (μ)), from the outside layer to the inside layer:
A ranges from about 6.00μ to about 20.00μ
B ranges from about 6.00μ to 20.00μ
C ranges from about 2.00μ to about 10.00μ
D ranges from about 2.00μ to about 20.00μ
E ranges from about 6.00μ to about 10.00μ
F ranges from about 0.750μ to about 5.00μ
G ranges from about 2.00μ to about 13.00μ.

Thickness of the total film ranges from about 25 microns to about 70 microns. As the extruded film is not exactly the same thickness throughout, a fact well known to those skilled in the art, the range of layer thickness and total film thickness will vary within accepted process parameters.

The function of the inner layer is primarily to provide an adhering surface for contact with the food stuff, typically being sausage meat. In the present invention, to fulfill this function, a thin inner layer is preferred for ease of processing. It is important that this inner layer be continuous over the inner surface of the tube and that it be extruded at a sufficient thickness to allow the desired degree of stretching without forming discontinuities in coverage. The inner layer of the present invention also provides good machinability and facilitates passage of the casing over shirring mandrels or stuffing horns without the necessity for addition of antiblock additives, polymeric plasticizers, or slip agents to the interior surface layer of the film.

The outer layer A and the adjoining layer B provide mechanical strength and act as a gas barrier, particularly for oxygen. When the outer layer A comprises a polyamide, the outer layer A is thicker than inner layer G, and together with layer B provides support and imparts strength to the casing wall in order to withstand stuffing, cooking, and handling pressures and abrasion. Alternatively, when the outer layer A comprises a polyolefin modified with functional groups, the outer layer A is thinner than inner layer G, and together with layer B has the same or similar characteristics.

In the present invention, inner layer G and outer layer A and adjoining layer B are comprised of polyamides, the adhesive layers C and E comprise LLDPE's such as a maleic anhydride grafted LLDPE, or a blend of LLDPE and EVA, or either with a color component, the first core layer D comprises an EVA having preferably 12% vinyl acetate units, while the second core layer F comprises an oxygen barrier of EVOH. The multilayer film has a shrinkage measured at 90° C. of at least about 3% to about 30% in both machine and transverse directions and at 60° C. of from 0% to about 8% in both MD and TD. By utilizing a multilayer film, the present invention overcomes disadvantages in monolayer polyamide casings of the prior art that sacrifice one or more desired functions such as moisture or gas impermeability, dimensional stability, uniformity of diameter, wrinkle resistance or meat adhesion for other functions including those listed above as well as processability or ease of manufacture.

Polyamides are polymers having recurring amide (—CONH—) linking units in the molecular chain. As defined herein, polyamides include a homopolyamide, a copolyamide, blends of copolyamides, or blends of copolyamides and homopolyamides. Polyamides also include nylon resins which are well known polymers having a multitude of uses including utility as packaging films, bags and casing. See, e.g., Modern Plastics Encyclopedia, 88 Vol. 64, No. 10A, pp. 34-37 and 554-555 (McGraw-Hill, Inc., 1987), which is hereby incorporated by reference. In particular, the novel thermoplastic flexible oriented multilayer films of the present invention are useful in food packaging. “Nylon” is a generic term for synthetic, high molecular weight (MW 10,000) linear polyamides. Suitable nylons are commercially available and may be prepared by well known methods including addition or self-condensation reactions, e.g., of amino acids or lactams and condensation reactions of diamines with diacids. Nylon polymers may be aliphatic or aromatic. Suitable nylon polymers may be homopolymers or copolymers such as bipolymers and terpolymers, and blends and modifications thereof.

Suitable preferred nylons for use in either or both of the inner G and outer A polyamide layers are believed to include nylon 6, nylon 6/12 copolymer, nylon 66/610 copolymer, and nylon 6/66 copolymer. Particularly preferred polyamides are aliphatic nylons such as nylon 6/66, or nylon 6/66 blended with nylon 66/610 or nylon 6. Alternatively, the outer layer A may be a polyolefin modified with functional groups such as maleic anhydride grafted LLDPE. Advantageously, the inner layer may comprise nylon 6 and the outer layer may comprise the copolyamide nylon 6/66 or maleic anhydride grafted LLDPE, which exhibits highly desirable properties of oxygen impermeability, mechanical strength, and ease of stretch orientation.

Suitable preferred nylons for use in layer B include nylon 6166 copolymer, nylon 6[12 copolymer or nylon 6 homopolymer. Blends of these types of homo and copolymers are also suitable.

Inner layer G preferably is the interior surface layer of the tubular article and beneficially the composition of this layer will have the characteristic of adhering to meat. Preferably, the composition of the inner layer G will allow for the inner layer's coextrusion as part of a multilayer film without detrimental delamination from any adjacent polymeric film layer during such operations as annealing, reeling, shirring, stuffing, cooking, refrigerating, and subsequent use. A further function of this inner layer is that it should not block when the tube is collapsed upon itself, and should facilitate opening of the tube and passage thereof over equipment such as shirring mandrels and stuffing horns. Advantageously, the present invention utilizes a polyamide which does not require internally applied antiblock coatings. However antiblocking agents and processing aids may be added to this and any other layer as needed to allow the film to be processed.

The thick outer layer A comprises a copolyamide, preferably nylon 6/66. Alternatively, a thin outer layer A comprises a polyolefin modified with functional groups, preferably maleic anhydride grafted LLDPE. It is desirable that the outer layer be protected by the second core layer from excessive moisture migration from encased foodstuffs which may impair the oxygen impermeability of the outer layer comprised of polyamide or polyolefin modified with functional groups. Thus, in the inventive casing the polyamide or polyolefin outer layer and the adjacent polyamide layer functions as an oxygen barrier and provides in combination with the other layers a casing with a sufficiently low oxygen transmission rate to prevent or substantially delay oxidative defects such as discoloration of the encased sausage meat. It has been found that suitable nylons will have a relative viscosity (ηᵣ) in 98% sulfuric acid of greater than about 4ηᵣᵣ. Polyamides having a relative viscosity of 4 and above are desired. Polyamides having relative viscosity values below 4 have an undesirably low melt viscosity for this invention that makes it more difficult to be extruded and oriented as tubes. Although it is not necessary for the present invention, additional processing aids, colorants, antiblock agents or adhesive components may be added to either, both, or all of the polyamide layers.

The relatively thick adhesive layers C and E function not only as an adhesive between the first core and the surrounding layers, but also as a water vapor barrier, and provide the film with the suppleness and proper modulus for good shirrability and orientation. The adhesive layers are composed of polyolefin resins modified with functional groups such as maleic anhydride grafted LLDPE, maleic anhydride grafted ethylene vinyl acetate (“EVA”), or maleic anhydride grafted LLDPE blended with a polyolefin based color master batch. The resins are composed of units of ethylene known as LLDPE. These are copolymers of ethylene and alpha-olefins, and have densities from 0.915 to 0.940 g/cm³. In particular, graft polymers of LLDPE are used, such as a maleic anhydride grafted LLDPE, such as those sold by Mitsui under the trade name Admer. For example, adhesive concentrates such as Bynel 4140, sold by E.I. DuPont de Nemours and Company, when blended with a fractional melt index EVA may also be used. Advantageously, ethylenic polymeric units are nonpolar and hydrophobic, imparting moisture barrier properties to the core layer. It is also in the adhesive layers that additional agents, such as coloring agents, may be added prior to extrusion to make a colored tubing.

The first core layer (D) comprises suitable copolymers of ethylene and esters, which include copolymers of ethylene and unsaturated esters especially vinyl esters. In one embodiment, copolymers of ethylene containing 8-12% units of vinyl acetate, preferably EVA, are used. In another embodiment, the first core layer (D) comprises one or more polyolefins such as LDPE, HDPE, LLDPE, and VLDPE.

Suitable core layer copolymers include ethylene-vinyl acetate, ethylene-methyl methacrylate, ethylene-ethyl methacrylate, and ethylene-alkyl acrylates such as ethylene-methyl acrylate, ethylene-ethyl acrylate and ethylene-butyl acrylate.

It is further contemplated that a blend of at least two different copolymers of ethylene and at least one unsaturated ester may be employed. Most preferred are vinyl ester copolymers of ethylene and especially preferred are the EVA copolymers. Many different EVA resins are commercially available having a wide range of vinyl acetate contents and melt flow indices.

To introduce color into the film, this core layer may be blended with a polyolefin based color. Advantageously, the core layer functions as a water vapor barrier, and provides the film with the suppleness and proper modulus for good shirrability and orientation. A detailed description of the polyolefins LDPE, HDPE, LLDPE, and VLDPE are found in U.S. Pat. No. 5,549,943 columns 12, line 6 through column 14, line 52, which is hereby incorporated in its entirety by reference.

VLDPEs and ethylene ester copolymers beneficially facilitate orientation and provide good adhesion and moisture barrier properties as well as shrink and shrink force properties which promote wrinkle resistance. Additionally, these materials provide suppleness and proper modulus to enable the inventive tubular films to be easily shirred and deshirred without undesirable breakage.

The second core layer F is an EVOH copolymer, and can be any derived EVOH polymer; it generally consists of between about 32-44 mole % ethylene units, preferably about 32-38 mole % ethylene units, and most preferably consists of 32 mole % ethylene units. The preferred EVOH, which includes lubricants and is in a stabilized formula, is sold under the trade name “Evalca H-171B” by Eval Company of America. Such lubricants and stabilizers are included in minimal amounts. EVOH is well known as being an oxygen barrier, even as a very thin layer in a multilayer film, but it is also known as a material difficult to stretch and orient. Incorporated as the core layer of this invention, the stretching difficulties are minimized.

The films of the present invention are biaxially stretched and oriented films. An important feature of the present invention is that the inventive films have sufficient shrinkage values and shrink forces to produce smooth wrinkle resistant casings able to closely conform to encased foodstuffs, no matter their shape, during heat processing, chilling, refrigeration and storage.

The multilayer film of the present invention is an oriented film that may be stretch oriented in one or more directions, preferably biaxially oriented by biaxial stretching in which the film is stretched in two directions which are preferably at 90° to one another.

It is important that the casings have at least about 3% and up to about 30% shrinkage, as measure at 90° C. in each of the MD and TD directions and to have sufficient shrink force to ensure good conformation of the casing to enclosed foodstuffs.

Biaxial orientation by biaxial stretching increases the tensile strength of films and decreases the percentage of elongation at break. Advantageously, the multilayer films of the present invention exhibit excellent mechanical strength.

General equipment and procedures similar to those described in U.S. Pat. No. 3,456,044 (Pahlke), may be employed in the present invention as modified as disclosed herein. Other orientation and stretching apparatus to uniaxially or biaxially stretch film are well known in the art and may be adapted by those skilled in the art to produce films of the present invention. Examples of such apparatus and processes are believed to include e.g. those disclosed in U.S. Pat. Nos. 4,886,634, and 5,549,943.

The inventive film may be made using a method for biaxially orienting thermoplastic films, in which a primary tube is formed by melt extruding a tube from an annular die. The primary tube can be made by any of the known techniques for extrusion of tubular plastic film including coextrusion and coating lamination methods. This extruded tube is cooled, collapsed, and then inflated between first and second means for blocking the interior of the tube which means are set apart from one another to form an isolated fluidic mass or bubble, and the inflated tube is advanced through a heating zone to bring the tube to its draw temperature. In a draw or orientation zone the tubing is radially expanded in the transverse direction and pulled or stretched in the machine direction at a temperature such that expansion occurs in both directions (preferably simultaneously)—the expansion of the tubing being accompanied by a sharp, sudden reduction of thickness at the draw point. The term heating zone is used to define a region which includes both a zone of preliminary heating of the primary tubing to the draw temperature and also the draw or orientation zone.

In the present invention the tubing may be biaxially stretched by passing the tubing through a heating zone and rapidly radially extending the tubing when the tubing is at the draw temperature. The extended tubing is contacted with a stream of cooling fluid, while extended in the heating zone, and the temperature of the cooling fluid at least at one point within the heating zone, is substantially below the temperature to which the tubing has been heated during its flow through the heating zone up to said at least at one point within said heating zone. The temperature of the cooling fluid in the draw zone is at least 10° F. (5° C.) below that of the tubing at the draw point. Preferably the cooling fluid is air, and a stream of high velocity air is blown in a generally upward direction, toward the radially extended portion of the tubing.

Alternatively, film of the present invention may be made by sheet extrusion or lamination with orientation e.g., by tentering. Tubes may be made from sheets of film by seaming using e.g. adhesives. In this manner various diameter tubes may be made from sheet film and tubular film may be slit and resized by seaming.

A preferred process of the present invention is a continuous process for making a tubular, biaxially stretched, heat shrinkable, multilayer thermoplastic food casing. This process may comprise:
(a) coextruding a melt plasticized multilayer thermoplastic tube having an exterior surface and an interior surface through an annular die wherein the tube comprises an outer polyamide layer, a second polyamide layer, an adhesive polyethylene layer, a first core layer of EVA, an adhesive polyethylene layer, a second core layer of EVOH, and an outer polyamide layer;
(b) cooling the coextruded tube below the melting point of each layer by applying water to the exterior surface of the tube;
(c) transferring the cooled tube to an orientation zone wherein the tube is reheated to a temperature below the melting point of the tube layer with the lowest melting point, followed by cooling while a fluid mass is admitted to the interior of the tube as said tube is passed between first and second means for blocking fluid flow along the interior of the tube, thereby causing the tube to stretch circumferentially about the entrapped fluid mass and simultaneous with the circumferential stretching, the tube is stretched in a direction perpendicular thereto to produce a biaxially stretched tubular film; and
(d) annealing the biaxially stretched film at elevated temperature to dimensionally stabilize the film.

The following are examples given to illustrate the present invention. Experimental results of the following examples are based on tests similar to the following test methods unless noted otherwise.
Tensile Strength: ASTM D-882, method A
% Elongation: ASTM D-882. method A
1% Secant Modulus: ASTM D-882, method A
Oxygen Gas Transmission Rate (O₂GTR): ASTM D-3985-81
Gauge: ASTM D-2103
   Shrinkage Values: Shrinkage values are defined to be values obtained by measuring unrestrained shrink at 90° C. for five seconds. Four test specimens are cut from a given sample of the film to be tested. The specimens are cut into squares of 10 cm length in the machine direction by 10 cm. length in the transverse direction. Each specimen is completely immersed for 5 seconds in a 90° C. water bath. The specimen is then removed from the water bath and the distance between the ends of the shrunken specimen is measured for both the MD and TD directions. The difference in the measured distance for the shrunken specimen and the original 10 cm. side is multiplied by ten to obtain the percent of shrinkage for the specimen in each direction. The shrinkage for the four specimens is averaged for the MD shrinkage value of the given film sample, and the shrinkage for the four specimens is averaged for the TD shrinkage value.

In all the following examples, unless otherwise indicated herein the film compositions were produced generally utilizing the apparatus and method described in U.S. Pat. No. 3,456,044 (Pahlke), which describes a coextrusion type of double bubble method and in further accordance with the detailed description above. All percentages are by weight unless indicated otherwise.

### EXAMPLE 1

One extruder was used for each layer, and the heat plasticized resins from each extruder were introduced to a coextrusion die from which the resins were coextruded at a ratio as given in each table for each film made.

The inner layer G resin was 97% Nylon 6 homopolymer from UBE Industries, Ltd. blended with 3% of an antiblock nylon from Techmer. The adhesive blend layers C and E consisted of 100% by maleic anhydride grafted LLDPE, either an Admer or Ateva brand. In Film 1 and 3, the first core layer D was an EVA resin, Ateva 1210. In Film 2, core D was 50% EVA resin blended with 50% polyethylene based color red, PM42260E90. The second core layer F was EVAL H171B (EVOH, 32 mole % ethylene) from Eval Company of America. The outer layer A and the adjacent layer B was Nylon 6/66, the 5033 FDX27 resin from UBE Industries, Ltd.

The resin or resin mixture was fed from a hopper into an attached single screw extruder where the resin was heat plasticized and extruded through a seven-layer coextrusion spiral die into a primary tube. Die temperatures were set at 250° C. The extruder multilayer primary tube was cooled by spraying with water at a temperature of 17° C. A primary tube was flattened by passage through a pair of nip rollers.

The primary tube was then reheated in a hot water bath maintained from 70 to 80° C. and biaxially stretched by a factor of 2.5 in the longitudinal direction and 3.31 in the transverse direction using a trapped bubble with airtight seal.

In a sequential step, the oriented film was annealed at a temperature that ranged from 200 to 300° C. A final film having a flat width from 190-192 was wound on a core. The films had 16-19%/18-22% MD/TD shrink, measured at 90° C.

Description and formulation of the three films are given below in Tables 1, 2, and 3.

TABLE 1
Film 1

| | | % of | | | |
|---|---|---|---|---|---|
| | | Layer | | Primary | % in |
| Extruder | Layer | Thickness | Resin Description | Designation | Layer |
| A | Outer | 25.00% | Nylon 6,66 | UBE 5033FDX57 | 100.00% |
| B | Outer | 25.00% | Nylon 6,66 | UBE 5033FDX57 | 100.00% |
| | Adhesive | | | | |
| C | Outer Core | 11.00% | Resin Plexar PX3227 | Plexar PX3227 | 100.00% |
| D | Core | 10.00% | EVA Resin | Ateva 1210 | 100.00% |
| E | Inner Core | 11.00% | Resin Plexar PX3227 | Plexar PX3227 | 100.00% |
| F | Inner | 5.00% | EVOH H171B | EVAL H171B | 100.00% |
| | Adhesive | | | | |
| G | Inner | 15.00% | Nylon 6 | UBE 1030B | 97.00% |
| | | | Anti-block Nylon | Techmer PNM | 3.00% |
| | | | | 12379 | |

TABLE 2
Film 2

| | | % of Layer | Resin | Primary | |
|---|---|---|---|---|---|
| Extruder | Layer | Thickness | Description | Designation | % in Layer |
| A | Outer-A | 25.00% | Nylon 6,66 | UBE | 100.00% |
| | | | | 5033FDX57 | |
| B | Outer | 25.00% | Nylon 6,66 | UBE | 100.00% |
| | Adhesive-B | | | 5033FDX57 | |
| C | Outer Core-C | 11.00% | Resin Admer | Admer AT- | 100.00% |
| | | | AT-1955 | 1955 | |
| D | Core-D | 10.00% | EVA Resin | Ateva 1210 | 100.00% |
| E | Inner Core-E | 11.00% | Resin Admer | Admer AT- | 100.00% |
| | | | AT-1955 | 1955 | |
| F | Inner | 3.00% | EVOH H171B | EVAL H171B | 100.00% |
| | Adhesive-F | | | | |
| G | Inner-G | 15.00% | Nylon 6 | UBE 1030B | 97.00% |
| | | | Anti-block | Techmer | 3% |
| | | | Nylon | PNM 12379 | |

TABLE 3
Film 3 (Colored)

| | | % of Layer | Resin | Primary | |
|---|---|---|---|---|---|
| Extruder | Layer | Thickness | Description | Designation | % in Layer |
| A | Outer-A | 25.00% | Nylon 6,66 | UBE | 100.00% |
| | | | | 5033FDX57 | |
| B | Outer | 25.00% | Nyon 6,66 | UBE | 100.00% |
| | Adhesive-B | | | 5033FDX57 | |
| C | Outer Core-C | 11.00% | Resin Admer | Admer AT- | 100.00% |
| | | | AT-1955 | 1955 | |
| D | Core-D | 10.00% | Resin Red | PM42260E90 | 50.00% |
| | | | EVA Resin | Ateva 1210 | 50.00% |
| E | Inner Core-E | 11.00% | Resin Admer | Admer AT- | 100.00% |
| | | | AT-1955 | 1955 | |
| F | Inner | 3.00% | EVOH | EVAL H171B | 100.00% |
| | Adhesive-F | | H171B | | |
| G | Inner-G | 15.00% | Nylon 6 | UBE 1030B | 97.00% |
| | | | Anti-block | Techmer | 3% |
| | | | Nylon | PNM 12379 | |

Properties of FILMS 1, 2, and 3 are given in Table 4.

TABLE 4
Properties of Films 1, 2, and 3.

| Test | Unit | Film 1 | Film 2 | Film 3 |
|---|---|---|---|---|
| THICKNESS PROFILE | MIL | 1.88/2.00/1.7 | 1.69/2.00/1.45 | 1.68/1.90/1.45 |
| (AVG/MAX/MIN) | | | | |
| FLAT WIDTH | MM | 190 | 192 | 192 |
| TENSILE STRENGTH | PSI | 22020/23820 | 20390/24510 | 21520/23420 |
| MD/TD | | | | |
| ELONGATION | % | 179/88 | 165/82 | 152/86 |
| MD/TD | | | | |
| SECANT MODULUS, | PSI | 183400/140900 | 200200/153500 | 196700/179300 |
| conditioned | | | | |
| MD/TD | | | | |
| SHRINK @ 90° C. | % | 16/18 | 17/19 | 19/22 |
| MD/TD | | | | |
| SHRINK @ 60° C. | % | 2/3 | 3/4 | 5/9 |
| MD/TD | | | | |
| OXYGEN TRANSMISSION | | 0.32174 | 0.615814 | 0.593657 |
| RATE | | | | |
| cc/100 in²/24 h atm | | | | |

### EXAMPLE 2

Seven pieces of each of control casings made from commercial casings known as Vismax and Visflex, registered trademarks of Viskase Companies, Inc. and Films 1, 2, and 3 were hand filled with a 85% lean pork trimmings emulsion. The meat was ground to a 1-inch size, added to a Rietz Blender with phosphate and blended for two minutes. The remaining ingredients were added and vacuum blended for thirty minutes, held overnight and then re-blended an additional thirty minutes prior to stuffing and thermally processing. The casings were pulled up on a Tipper Press Tie at approximately 40 psi to their respective stuff diameters. The formulation consisted of:

TABLE 5
Meat Formulation

| | Weight |
|---|---|
| 1) Ingredient | (#) |
| Lean Pork Loin Trimmings (85% Lean) | 436.43 |
| Water (25%) | 109.11 |
| Salt | 9.82 |
| Brown Sugar | 7.64 |
| Phosphate - Brifisol 512 | 2.18 |
| Prague Powder - Curing Salt | 1.09 |
| GPC Modified Food Starch | 8.73 |

Jourdan Cook Schedule

| | Dry | Wet | |
|---|---|---|---|
| | Bulb | Bulb | Time |
| Step | (° F.) | (° F.) | (min.) |
| 1 | 140 | 140 | 45 |
| 2 | 160 | 160 | 45 |
| 3 | 180 | 180 | 45 |
| 4 | 190 | 190 | 30 (IT = 165° F.) |

| | |
|---|---|
| 5 | 45 minute cold water shower |

After thermal processing and chilling, the samples were placed in a display case (35° F.) and exposed to fluorescent lighting 24 hours a day for four months. One sample was pulled initially and then another sample was pulled at 2 weeks, 4 weeks, 9 weeks, 11 weeks, and then at 4 months.

Visually and calorimetrically, the samples of Film 1 were slightly lighter throughout the four month study, but both the controls and the inventive films maintained their initial color at the end of the evaluation.

Control casings were Colorimetrically slightly darker than Films 2 and 3 throughout the study, but after four months, both the controls and inventive films were similar in darkness and redness. The clear samples of the control and inventive film tended to get lighter throughout the evaluation.

The control casings exhibited more of a per cent increase in diameter and per cent decrease in length and per cent weight loss than their corresponding inventive samples.

What we claim:

1. A tubular, biaxially stretched, heat shrinkable, multilayer thermoplastic film food casing comprising:
an outer surface layer (A) comprising a polyamide or a polyolefin modified with functional groups;
a second layer (B) comprising a polyamide;
a first adhesive layer (C) comprising an polyolefin modified with functional groups:
a first core layer (D) comprising a (i) copolymer of ethylene and an unsaturated ester, or (ii) one or more of polyolefins comprising a low density polyethylene (“LDPE”), a high density polyethylene (“HDPE”), a linear low density polyethylene (“LLDPE”), and very low density polyethylene (“VLDPE”);
a second adhesive layer (E) of a polyolefin modified with functional groups;
a second core layer (F) comprising ethylene vinyl alcohol copolymer (“EVOH”); and
an inner surface layer (G) comprising a polyamide,
wherein the inner surface layer (G) is a food contacting layer and the outer surface layer (A) is a non-food contacting layer; and
wherein the inner surface layer (G) is thinner than the outer surface layer (A) when the outer surface layer (A) comprises a polyamide or the inner surface layer (G) is thicker than the outer surface layer (A) when the outer surface layer (A) comprises a polyolefin modified with functional groups.

2. The multilayer film according to claim 1, wherein the polyamide comprises a homopolyamide, a copolyamide, blends of copolyamides, or blends of copolyamides and homopolyamides.

3. The multilayer film according to claim 1, wherein the first core layer (D) further comprises a polyolefin based color master batch in a blend with the (i) copolymer or the (ii) one or more of polyolefins.

4. The multilayer film according to claim 1, wherein the polyolefin modified with functional groups comprises maleic anhydride grafted LLDPE, maleic anhydride grafted ethylene vinyl acetate (“EVA”), or maleic anhydride grafted LLDPE blended with a polyolefin based color master batch.

5. The multilayer film according to claim 1, wherein the film has a shrinkage value of about 3% to about 30% in both the machine and transverse direction (“MD” and “TD”) at 90° C. and from 0% to about 8% at 60° C.

6. The multilayer film according to claim 1, wherein
the polyamide outer (A) comprises (iii) nylon 6/66 copolymer either alone or blended with nylon 66/610 copolymer or nylon 6 homopolymer or (iv) maleic anhydride grafted LLDPE;
the second layer (B) comprises a nylon 6/66 copolymer, nylon 6/12 copolymer, or nylon 6 homopolymer;
the adhesive layer (C) comprises maleic anhydride grafted LLDPE;
The first core layer (D) comprises EVA;
the second core layer (F) comprises EVOH having between about 32 to about 44 mole % ethylene;
the adhesive layer (E) comprises maleic anhydride grafted LLDPE; and
the second core layer (F) comprises EVOH having between about 32 to about 44 mole % ethylene;; and
the inner (G) surface comprises nylon 6/66 copolymer either alone or blended with nylon 66/610 copolymer or nylon 6 homopolymer, wherein the interior surface layer has a thickness that is less than that of the exterior surface layer.

7. The multilayer film according to claim 5, wherein the EVOH has between about 32 to about 44 mole % ethylene.

8. The multilayer film according to claim 1, wherein the film has a thickness of about 25 to about 70 microns.

9. The multilayer film according to claim 1, further comprising one or more additional layers of either or both of the inner or outer surface layers of the tube.

10. The multilayer film according to claim 1, further comprising one or more additional layers (A), (B), (C), (D), (E), (F) or (G).

11. The multilayer film according to claim 1, wherein the thickness of
outer surface layer A ranges from about 6.00μ to about 20.00μ;
second layer B ranges from about 6.00μ to 20.00μ;
first adhesive layer C ranges from about 2.00μ to about 10.00μ;
first core layer D ranges from about 2.00μ to about 20.00μ;
second adhesive layer E ranges from about 6.00μ to about 10.00μ;
second core layer F ranges from about 0.750μ to about 5.00μ; and
inner surface layer G ranges from about 2.00μ to about 13.00μ.

12. The multilayer film according to claim 1, wherein the inner surface layer (G) is continuous over the inner surface of the tube and extruded at a sufficient thickness to allow the desired degree of stretching without forming discontinuities in coverage.

13. A multilayer film according to claim 1, wherein:
the outer surface layer (A) comprises a polyamide or a polyolefin modified with functional groups;
each of the inner surface layer (G), and the second layer (B) comprise a polyamide;
each of adhesive layers (C) and (E) comprise maleic anhydride grafted LLDPE, maleic anhydride grafted ethylene vinyl acetate (“EVA”), or maleic anhydride grafted LLDPE, optionally blended with a polyolefin based color master batch;
the first core layer (D) comprising an EVA having about 8-12% vinyl acetate units, the EVA optionally blended with polyolefin based color master batch;
the second core layer F comprising EVOH.

14. The multilayer film according to claim 13, wherein the LLDPE, a maleic anhydride grafted LLDPE, or a blend of LLDPE and EVA of adhesive layers (C) and (E) is further blended with a polyolefin color master batch.

15. The multilayer film according to claims 1 or 13, wherein the inner surface layer (G) comprise nylon 6, nylon 6/12 copolymer, nylon 66/610 copolymer, or nylon 6/66 copolymer and outer surface layer (A) comprise nylon 6, nylon 6/12 copolymer, nylon 66/610 copolymer, nylon 6/66 copolymer, or maleic anhydride grafted LLDPE.

16. The multilayer film according to claims 1 or 13, wherein the inner surface layer (G) comprise nylon 6/66, alone or blended with nylon 66/610 or nylon 6, and outer surface layer (A) comprise nylon 6/66, a blend of nylon 6/66 with nylon 66/610 or nylon 6, nylon 6/66 copolymer, or maleic anhydride grafted LLDPE.

17. The multilayer film according to claims 1 or 13, wherein the inner surface layer (G) comprises nylon 6 and the outer surface layer (A) comprise co-polyamide nylon 6/66 or maleic anhydride grafted LLDPE.

18. The multilayer film according to claims 1 or 13, wherein second layer (B) comprises nylon 6/66 copolymer, nylon 6/12 copolymer or nylon 6 homopolymer, or blends of any one of the foregoing.

19. The multilayer film according to claims 1 or 13, wherein the inner surface layer (G) is the interior surface layer of the tubular food casing and has the characteristic of adhering to meat.

20. The multilayer film according to claims 1 or 13, wherein the outer surface layer (A) comprises a copolyamide, preferably nylon 6/66 or maleic anhydride grafted LLDPE.

21. The multilayer film according to claims 1 or 13, wherein the polyamide comprises a nylon having a relative viscosity (ηᵣ) in 98% sulfuric acid of greater than about 4ηᵣᵣ.

22. The multilayer film according to claim 21, wherein the polyamide has a relative viscosity value of 4 and above.

23. The multilayer film according to claim 1, wherein the polyolefin modified with functional groups comprise a LLDPE having a density ranging from about 0.915 to about 0.940 g/cm³.

24. The multilayer film according to claim 23, wherein the polyolefin modified with functional groups comprises grafted polymers of LLDPE.

25. The multilayer film according to claim 24, wherein the grafted polymers of LLDPE is a maleic anhydride grafted LLDPE.

26. The multilayer film according to claim 1, wherein the unsaturated ester comprises vinyl acetate.

27. The multilayer film according to any one of claims 1 or 25, wherein copolymers of ethylene and unsaturated ester comprise copolymers of ethylene-vinyl acetate, copolymers of ethylene-methyl methacrylate, copolymers of ethylene-ethyl methacrylate, or copolymers of ethylene-alkyl acrylates.

28. The multilayer film of claim 27, wherein copolymers of ethylene-alkyl acrylates comprise ethylene-methyl acrylate, ethylene-ethyl acrylate or ethylene-butyl acrylate.

29. The multilayer film of any one of claims 1 or 13, wherein the EVOH copolymer comprises between about 32 to about 44 mole % ethylene units.

30. The multilayer film of claim 29, wherein the EVOH copolymer comprises between about 32 to about 44 mole % ethylene units.

31. The multilayer film of claim 30, wherein the EVOH copolymer comprises about 32 mole % ethylene units.

32. A tubular, biaxially stretched, heat shrinkable, multilayer thermoplastic film food casing comprising:
an inner layer (G) comprising a blend of Nylon 6 homopolymer and optional antiblock nylon;
adhesive layers (C) and (E) comprise maleic anhydride grafted LLDPE;
a first core layer (D) comprises EVA or a blend of about 50% EVA with about 50% polyethylene based color master batch;
a second core layer (F) comprising EVOH with about 32% by mole ethylene;
an outer layer (A) comprises Nylon 6/66 or maleic anhydride grafted LLDPE; and
second layer (B) comprises Nylon 6/66.

33. The multilayer film according to claim 32, wherein:
when outer layer (A) comprises Nylon 6/66, the outer layer (A) and second layer (B), each layer comprises about 25% of the film layer thickness;
first adhesive layer (C) and second adhesive layer (E), each layer comprising about 11% of the film layer thickness;
first core layer (D) comprises about 10% of the film layer thickness;
second core layer (F) comprises about 3% of the film layer thickness; and
inner layer (G) comprises about 15% of the film layer thickness.

34. The multilayer film according to claim 32, wherein:
outer layer (A) and second layer (B), each layer comprising about 25% of the film layer thickness;
first adhesive layer (C) and second adhesive layer (E) each comprise about 10% of the film layer thickness;
first core layer (D) comprises about 10% of the film layer thickness;
second core layer (F) comprises about 5% of the film layer thickness; and
inner layer (G) comprises about 15% of the film layer thickness.

35. A continuous process for making a tubular, biaxially stretched, heat shrinkable, multilayer thermoplastic food casing, the process comprising:
(a) co-extruding a melt plasticized multilayer thermoplastic tube having an exterior surface and an interior surface through an annular die wherein the tube comprises an outer layer comprising a polyamide or a polyolefin modified with functional groups, a second polyamide layer, an first adhesive polyethylene layer, a first core layer of EVA, a second adhesive polyethylene layer, a second core layer of EVOH, and an outer polyamide layer;
(b) cooling the coextruded tube below the melting point of each layer by applying water to the exterior surface of the tube;
(c) transferring the cooled tube to an orientation zone wherein the tube is reheated to a temperature below the melting point of the tube layer with the lowest melting point, followed by cooling while a fluid mass is admitted to the interior of the tube as said tube is passed between first and second means for blocking fluid flow along the interior of the tube, thereby causing the tube to stretch circumferentially about the entrapped fluid mass and simultaneous with the circumferential stretching, the tube is stretched in a direction perpendicular thereto to produce a biaxially stretched tubular film; and
(d) annealing the biaxially stretched film at elevated temperature to dimensionally stabilize the film.
